(19) United States
(12) Patent Application Publication
(10) Pub. No.: US 2007/0025207 A1
(43) Pub. Date: Feb. 1, 2007

(54) Optical pickup and optical disk apparatus

(76) Inventors: Katsuhiko Izumi, Kamakura (JP); Shinya Fujimori, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/492,949

(22) Filed: Jul. 26, 2006

(30) Foreign Application Priority Data
Jul. 29, 2005 (JP) 2005-219898

(51) Int. Cl. G11B 7/00

(52) U.S. Cl. 369/44.37

(57) ABSTRACT

A first laser light source for emitting an optical beam of a first wavelength, a second laser light source for emitting an optical beam of a second wavelength different from the first wavelength and first and second polarizing devices through which the optical beams of first and second wavelengths transmit are provided. The first polarizing device changes the phase of the optical beam of first wavelength by about (M+½) times the first wavelength (M being integer) and the second polarizing device changes the phase of the optical beam of second wavelength by about (N+½) times the second wavelength (N being integer).

The present application claims the priority based on Japanese Patent Application No. 2005-219898 filed on Jul. 29, 2005 and incorporates the anterior application by making reference to the contents thereof.

### BACKGROUND OF THE INVENTION

The present invention relates to an optical pickup for reproducing information recorded on an optical disc and an optical disc apparatus.

An optical pickup apparatus provided with a two-wavelength laser unit having two kinds of laser devices of different laser wavelengths is disclosed in which, of the laser devices corresponding to two kinds of recording media, respectively, one laser device corresponding to one recording medium having a larger substrate thickness up to the signal recording surface has a light emitting point made to be coincident with the optical axis of an objective lens (for example, Patent Document 1(JP-A-2001-307367)).

Besides, in connection with a laser correction apparatus provided with a wavelength plate upon which two linearly polarized beams of different wavelengths having mutually parallel polarization planes and traveling on mutually parallel optical paths are incident and a birefringent plate upon which the two linearly polarized beams having transmitted through the wavelength plate are incident, an optical path correction unit is disclosed according to which the wavelength plate generates a phase difference of π·(2n−1) for one linearly polarized beam and a phase difference of 2π·m for the other linearly polarized beam (n and m being integers) and the birefreingent plate is arranged having its optical axis coincident with the polarization plane any one of the two linearly polarized beams having transmitted through the wavelength plate has (for example, Patent Document 2 (JP-A-2005-18960)).

Outgoing polarization directions of the two different optical beams at the two-wavelength laser, however, do not sometimes coincide with each other because of manufacturing irregularities and consequently, optical efficiency and polarization state become irregular in the course of transmission or reflection of the optical beams through or at the midway optical parts, giving rise to a problem that the desired optical pickup performance cannot be assured.

For example, in a two-wavelength laser carrying a laser device for DVD and a laser device for CD, the respective laser devices cannot be uniform in mounting position and mounting angle and the individual optical beams are emitted in directions deviating from the normal direction, with the result that the outgoing polarization directions possibly deviate from the normal polarization direction. If, in such an event, the mounting position and mounting angle of a polarizing device disposed in an optical path are adjusted so that the polarization direction of an optical beam for DVD may be corrected, a shift is disadvantageously caused in the polarization direction of an optical beam for CD whereas if the mounting position and mounting angle of the polarizing device disposed in the optical path are adjusted in order for the polarization direction of the optical beam for CD to be corrected, a shift is disadvantageously caused in the polarization direction of the optical beam for DVD.

The aforementioned JP-A-2001-307367 in no way refers to this point and cannot deal with shifting of the polarization direction of optical beam. And also, in the JP-A-2005-18960, the signal wavelength plate changes the polarization direction of an optical beam, so that with the polarization direction of an optical beam for DVD corrected, the polarization direction of an optical beam for CD is shifted and conversely, with the polarization direction of the optical beam for CD corrected, the polarization direction of the optical beam for DVD is shifted.

### SUMMARY OF THE INVENTION

Accordingly, an object of the present invention is to solve the problems as above and provide a highly reliable optical pickup and a highly reliable optical disc apparatus.

To solve the aforementioned problems, the present invention comprises a first laser light source for emitting an optical beam of a first wavelength, a second laser light source for emitting an optical beam of a second wavelength different from the first wavelength, a first polarizing device through which the optical beams of the first and second wavelengths transmit, a second polarizing device through which the optical beams of the first and second wavelengths transmit, and an objective lens for focusing an optical beam having transmitted through the first and second polarizing devices on an optical disc.

The first polarizing device changes the phase of the optical beam of first wavelength by about (M+½) times the first wavelength (M being integer) and the second polarizing device changes the phase of the optical beam of second wavelength by about (N+½) times the second wavelength (N being integer).

According to the present invention, a highly reliable optical pickup and a highly reliable optical disc apparatus can be provided.

Other objects, features and advantages will become apparent by reading a description of embodiments of the invention in conjunction with the accompanying drawings.

### BRIEF DESCRIPTION OF THE DRAWINGS

FIG. 1 is a diagram showing an instance where a laser of 660 nm is turned on in an optical pickup constructed according to embodiment 1.

FIG. 2 is a diagram showing an instance where a laser of 785 nm is turned on in the optical pickup of embodiment 1.

FIG. 3 is a diagram showing laser chips mounted on a two-wavelength laser.

FIGS. 4A and 4B are diagrams each showing a polarization direction of an optical beam emitted from a semiconductor laser.

FIGS. 5A and 5B are diagrams each showing a deviation of polarization direction of an optical beam emitted from the semiconductor laser.

FIG. 6 is a graph showing characteristics of wavelength plates 2 and 3 in embodiment 1.

FIG. 7 is a graph showing characteristics of a half mirror in embodiment 1.

FIG. 8 is a diagram showing the polarization state during reproduction of a first optical disc in embodiment 1.

FIG. 9 is a diagram showing the polarization state during reproduction of a second optical disc in embodiment 1.

FIGS. 10A and 10B are graphs each showing results of calculation of going-path efficiency when the emission polarization angle of the 660 nm laser in embodiment 1 shifts.

FIGS. 11A and 11B are graphs each showing results of calculation of going-path efficiency when the emission polarization angle of the 785 nm laser in embodiment 1 shifts.

FIG. 12 is a diagram showing an optical system configuration of an optical pickup according to embodiment 2.

FIG. 13 is a graph showing characteristics of wavelength plates 30 and 31 in embodiment 2.

FIG. 14 is a graph showing characteristics of a half mirror in embodiment 2.

FIG. 15 is a diagram showing an optical system configuration of an optical pickup according to embodiment 3.

FIG. 16 is a graph showing characteristics of wavelength plates 31 and 32 in embodiment 3.

FIG. 17 is a schematic block diagram of an optical disc apparatus carrying the optical pickups according to embodiments 1 to 3.

### DESCRIPTION OF THE EMBODIMENTS

Specified construction for carrying out the present invention will be described hereunder by using embodiments 1 to 4.

[Embodiment 1]

Embodiment 1 of the invention will be described by way of the construction of an optical pickup with reference to the drawings.

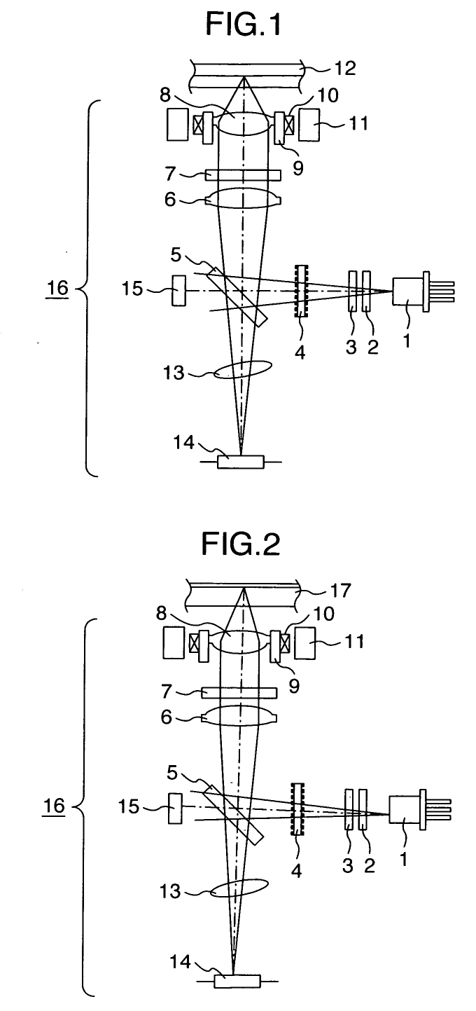

FIG. 1 is a diagram showing the construction of the optical pickup according to embodiment 1 of the invention. In FIG. 1, a semiconductor laser 1 is a two-wavelength laser capable of oscillating at wavelengths in 660 nm band and 785 nm band and oscillatory wavelengths are set to 660 nm and 785 nm at normal temperature. The 660 nm-band provides wavelengths which permit reproduction of a DVD and the 785 nm-band provides wavelengths which permit reproduction of a CD. Illustrated in FIG. 1 is a state in which an optical beam having a wavelength of 660 nm is emitted. The optical beam emitted from the semiconductor laser 1 takes the form of an optical beam polarized in a direction parallel to the sheet of drawing (hereinafter termed P polarization). The optical beam transmits through wavelength plates 2 and 3 located immediately before the semiconductor laser. The wavelength plate 2 acts as a half wavelength plate for only the 660 nm optical beam and the wavelength plate 3 acts as a half wavelength plate for only the 785 nm optical beam. Details of characteristics of the wavelength plates 2 and 3 will be described later. The wavelength plate 2 has an azimuth angle set to make 45° to the sheet of drawing and as a result, when transmitting through the wavelength plate 2, the optical beam is converted from P polarization to a polarization state vertical to the sheet of drawing (hereinafter termed S polarization). Since the wavelength plate 3 does not generate a phase difference for the 660 nm optical beam, the polarization state of S polarization of the optical beam having transmitted through the wavelength plate 3 remains unchanged. The optical beams having transmitted through the wavelength plate 3 reach a diffraction grating 4.

The grating 4 functions to cause the incident optical beam to be branched to three optical beams of 0-th order beam and ±1st order beams in order that three optical spots can be formed on an optical disc, having a grating plane acting on only the 660 nm optical beam on one side of grating 4 confronting the semiconductor laser 1 and a grating plane acting on only the 785 nm optical beam on the other side of grating 4 opposite to the semiconductor laser 1. Therefore, the 660 nm optical beam is caused to branch by the grating plane of grating 4 confronting the semiconductor laser to three optical beams of 0-th order beam and ±1st order beams which in turn reach a half mirror 5.

The half mirror 5 is an optical device which is so disposed as to make an angle of 45° to the outgoing optical axis of the optical beam emitted from the semiconductor laser 1 so that a film formed on its surface may reflect the S polarization component of the optical beams having wavelengths in the 660 nm and 785 nm bands by about 80% and the P polarization component thereof by about 40%. Thus, 80% of the optical beam in S polarization condition reaching the half mirror 5 is reflected in a direction making 90° to the incident direction. It will be appreciated that about 20% of the S polarization component of the optical beam transmits through the half mirror 5 and part thereof arrives at a front monitor for monitoring the quantity of light of the optical beam.

The optical beam reflected at the reflection film of half mirror 5 is converted into a collimating optical beam by means of a collimating lens 6. An optical beam going out of the collimating lens 6 transmits through a wideband wavelength plate 7. In case the optical beam having transmitted through the collimating lens 6 is S polarized light, it is converted into circularly polarized light by means of the wideband wavelength plate 7 and thereafter made to be incident on an objective lens 8. The objective lens 8 is a lens having the function to permit an incoming collimating optical beam in 660 nm band to be focused on an information recording surface of a first optical disc 12 having a substrate thickness of 0.6 mm such as for example a DVD and to permit an incoming collimating optical beam in 785 nm band to be focused on an information recording surface of a second optical disc 17 having a substrate thickness of 1.2 mm such as for example a CD.

The objective lens 8 is held by an actuator 9 integral with a drive coil 10 and a magnet 11 is arranged at a position opposing the drive coil 10. Then, structurally, when the drive coil 10 is supplied with electric power and affected by a repulsion force by the magnet 11 to generate a drive force, the objective lens 8 can be moved substantially radially of the optical disc 12 or 17 and vertically of the disc surface as well. Then, an optical beam having transmitted through the objective lens 8 can be presumed to provide either the quantity of light of the optical beam transmitting through the objective lens 8 or the quantity of light of an optical spot focused on the optical disc 12 on the basis of the quantity of light detected by the front monitor 15.

The optical beam reflected at the optical disc 12 traces an optical path similar to the going optical beam path in a direction reverse thereto and reaches the wideband wavelength plate 7 via the objective lens 8. The polarization of most of the optical beam reflected at the optical disc 12 and incident on the wideband wavelength plate 7 is circle polarization identical to that in the going path and therefore, this circle polarization is converted into P polarization after being transmitted through the wideband wavelength plate 7. Thereafter, the reflected optical beam is incident on the collimating lens 6 and converted from the collimating beam to a converged beam by means of the collimating lens 6, finally reaching the half mirror 5. The optical beam reaching the half mirror 5, most of which is P polarized light, is affected by the film surface of half mirror 5 so that about 60% of the optical beam may transmit through the half mirror 5.

The optical beam being in transmission through the half mirror 5 has already been formed into the converged beam after transmission through the collimating lens 6 and in the course of transmission through the half mirror 5 inclined in a direction making 45° to the travel direction of the optical beam, it undergoes an astigmatic aberration. Subsequently, the optical beam transmits through a detecting lens 13 and is then focused on a predetermined photo-detecting surface of a photodetector 14. The detecting lens 13 is a lens for canceling a coma aberration generated in the half mirror 5 and for enlarging the synthesized focal distance on the detection system side. Responsive to the received optical beam, the detector 14 can deliver a servo signal or a reproduction signal obtained from the optical disc 12 or 17.

As described above, by combining optical parts and electrical parts, an optical pickup 16 can be configured.

FIG. 2 shows an instance where a laser of 785 nm is turned on in the optical pickup according to embodiment 1 of the invention. A light emitting point of a 785 nm optical beam in the semiconductor laser 1 shifts from that of the 660 nm optical beam by about 110 μm and therefore, the optical beam is emitted from a position different from that for the 660 nm optical beam shown in FIG. 1. The optical beam emitted from the semiconductor laser 1 is polarized in a direction parallel to the sheet of drawing (hereinafter termed P polarization) and it transmits through the wavelength plates 2 and 3 located immediately before the semiconductor laser. As described previously, the wavelength plate 2 acts as a half wavelength plate for only the 660 nm optical beam and the wavelength plate 3 acts as a half wavelength plate for only the 785 nm optical beam, having its azimuth angle so set as to make 45° to the sheet of drawing. Accordingly, the polarization state of the optical beam having transmitted through the wavelength plate 2 remains unchanged, maintaining P polarization and in the course of subsequent transmission of the optical beam through the wavelength plate 3, the P polarization is converted to S polarization. The optical beam having transmitted through the wavelength plate 3 comes to the grating 4. The grating 4 has on its side opposite to the semiconductor laser 1 a grating plane acting on only the 785 nm optical beam and hence, the 785 nm optical beam is caused by the grating plane of grating 4 to branch to three optical beams of 0-th order and ±1st order which in turn reach the half mirror 5. Of the optical beam in S polarization condition reaching the half mirror 5, 80% is reflected in a direction making 90° to the incident direction. Of the S polarization component of optical beam, about 20% transmits through the half mirror 5 and part of the optical beam reaches the front monitor 15 for monitoring the quantity of light of the optical beam.

The optical beam reflected at the reflecting film of half mirror 5 is converted into a collimating beam by means of the collimating lens 6. The optical beam going out of the collimating lens 6 transmits through the wideband wavelength plate 7. In case the optical beam having transmitted through the collimating lens 6 is in S polarization condition, this optical beam is circularly polarized by means of the wideband wavelength plate 7 and thereafter made to be incident on the objective lens 8. The objective lens 8 focuses the optical beam on an information recording surface of the second optical disc 17 having the 1.2 mm thick substrate, for example, a CD. Structurally, an optical beam having transmitted through the objective lens 8 can be presumed to provide either the quantity of light of the optical beam transmitting through the objective lens 8 or the quantity of light of an optical spot focused on the optical disc 17 on the basis of the quantity of light detected by the front monitor 15.

The optical beam reflected at the optical disc 17 traces an optical path similar to the going optical beam path in a direction reverse thereto and reaches the wideband wavelength plate 7 via the objective lens 8. Polarization of most of the optical beam incident on the wideband wavelength plate 7 is circle polarization identical to that in the going path and therefore, this circle polarization is converted into P polarization after being transmitted through the wideband wavelength plate 7. Thereafter, the optical beam is made to be incident on the collimating lens 6 by which the optical beam is converted from the collimating beam into a converged beam which in turn reaches the half mirror 5. Most of the optical beam reaching the half mirror 5 is in P polarization condition and therefore the film surface of half mirror 5 permits about 60% of the optical beam to transmit through the half mirror 5.

The optical beam being in transmission through the half mirror 5 has already been formed into the converged beam after transmission through the collimating lens 6 and in the course of transmission through the half mirror 5 inclined in a direction making 45° to the travel direction of the optical beam, it undergoes an astigmatic aberration. Subsequently, the optical beam transmits through the detecting lens 13 and is then focused on the predetermined photo-detecting surface of photodetector 14. The detecting lens 13 is a lens for canceling a comma aberration generated in the half mirror 5 and for enlarging the synthesized focal distance on the detection system side. Responsive to the received optical beam, the detector 14 can deliver a servo signal and a reproduction signal obtained from the optical disc 17.

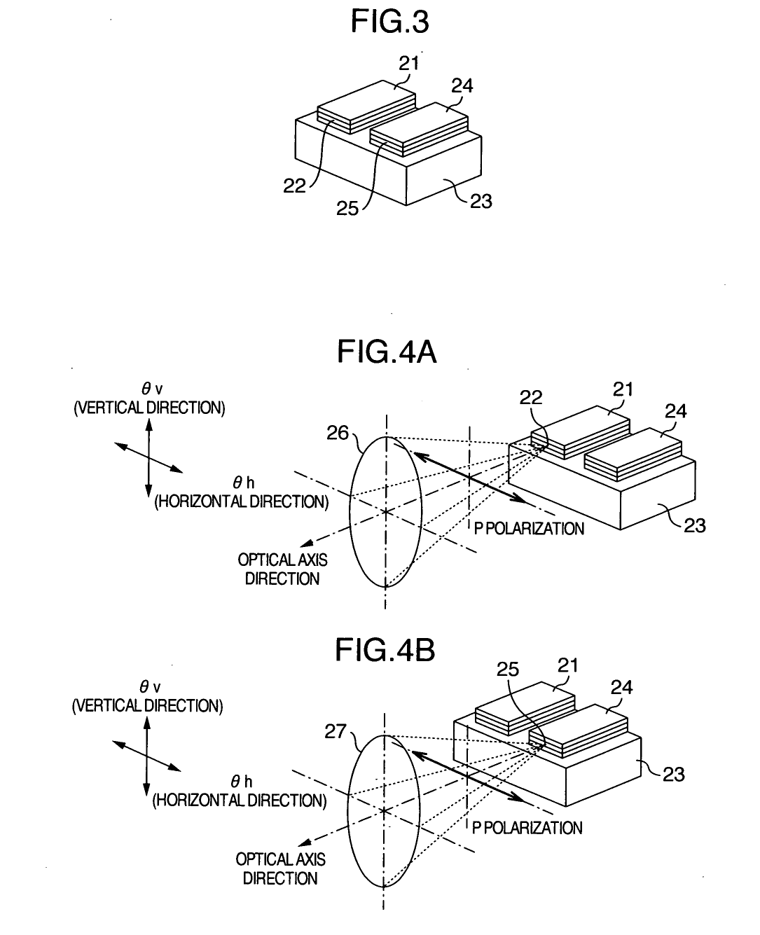

Next, a description will be given of laser chips mounted on the two-wavelength laser by making reference to FIG. 3. In FIG. 3, a laser chip 21 is for emitting an optical beam in 660 nm band and a laser tip 24 is for emitting an optical beam in 785 nm band, these two laser chips being both mounted on or formed integrally with a substrate 23 and a resultant structure being mounted internally of the semiconductor laser 1 described in connection with FIGS. 1 and 2. Formed internally of the laser chips 21 and 24 are activation layers 22 and 25, respectively. An optical beam is emitted from an end surface of each of the activation layers. The activation layers 22 and 25 are spaced apart from each other by about 110 μm.

Next, the polarization direction an optical beam undergoes after being emitted from the semiconductor laser will be described with reference to FIGS. 4A and 4B.

FIG. 4A shows an instance where an optical beam in 660 nm band is emitted and FIG. 4B shows an instance where an optical beam in 785 nm band is emitted. In FIG. 4A, the optical beam in 660 nm band emitted from an end surface of activation layer 22 of the laser chip 21 in a direction substantially parallel to the longitudinal direction of laser chip 21 has, in relation to the optical axis of optical beam, a narrow divergent angle in a direction θh parallel to the activation layer 22 (horizontal direction) and a wide divergent angle in a direction θv orthogonal to the activation layer 22 (vertical direction). For example, the divergent angles are approximately 9° and 18°, respectively, and divergence 26 of the optical beam has an elliptical intensity distribution having its major axis in θv direction. Then, the oscillation plane the optical beam emitted from the laser chip 21 has coincides substantially with a plane parallel to the activation layer 22, that is, the θh direction, so that the optical beam is in so-called P polarization condition to oscillate in a direction arrowed in the figure.

In FIG. 4B, the optical beam in 785 nm band emitted from an end surface of activation layer 25 of the laser chip 24 in a direction substantially parallel to the longitudinal direction of laser chip 24 has, in relation to the optical axis of the optical beam, a narrow divergent angle in a direction θh parallel to the activation layer 25 (horizontal direction) and a wide divergent angle in a direction θv orthogonal to the activation layer 25 (vertical direction). For example, these divergent angles are approximately 9° and 18°, respectively, and divergence 27 of the optical beam has an elliptical intensity distribution having its major axis in θv direction. Then, the oscillation plane the optical beam emitted from the laser chip 24 has coincides substantially with a plane parallel to the activation layer 25, that is, the θh direction, so that the optical beam is in so-called P polarization condition to oscillate in a direction arrowed in the figure.

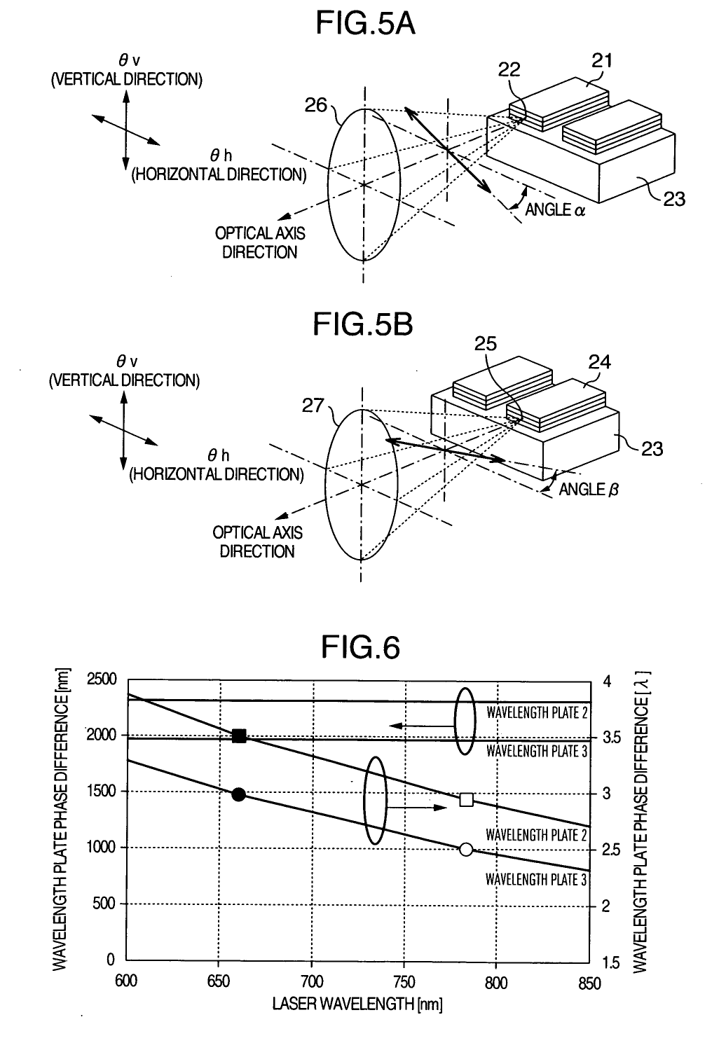

Next, how the polarization direction of an optical beam emitted from the semiconductor laser deviates will be described with reference to FIGS. 5A and 5B.

In FIG. 5A, the polarization direction of an optical beam emitted from the laser chip 21 deviates by an angle α from the original P polarization direction (θh direction) on account of the fact that internal stress or irregularity in manufacture is caused when the laser chip 21 is mounted on or formed in the substrate 23. Likewise, as shown in FIG. 5B, the polarization direction of an optical beam emitted from the laser chip 24 deviates by an angle β from the original P polarization direction (θh) on account of the fact that internal stress or irregularity in manufacture is caused when the laser chip 24 is mounted on or formed in the substrate 23. Each of the angles α and β has an independent value for every semiconductor laser and is expected to vary within a range of about ±15° at the worst. Namely, in an actual two-wavelength laser, the optical beams emitted from the laser chips are polarized in polarization directions which deviate from the P polarization by the angles α and β, respectively. With the deviation of the polarization direction caused, the optical efficiency or polarization state varies when the optical beam transmits through optical parts on an optical path or is reflected thereby and possibly, the desired optical pickup performance cannot be assured. In trying to correct the inconvenience with the conventional technology, both the deviations by angle α associated with the laser chip 21 and by angle β associated with the laser chip 24 cannot be eliminated. Accordingly, it is important to eliminate the deviation of the polarization direction and take a counterplot for enabling the optical pickup to assure the desired performance. To realize this end, according to the present embodiment, two wavelength plates having predetermined characteristics to be described below are provided.

Next, characteristics of the wavelength plates in embodiment 1 of the invention will be described with reference to FIG. 6. Illustrated in FIG. 6 are characteristics of the wavelength plates 2 and 3. In FIG. 6, abscissa represents the laser wavelength of an optical beam incident on the wavelength plate, ordinate on the left side represents the phase difference of the wavelength plate generates in a unit of length and ordinate on the right side represents the phase difference the wavelength plate generates which is normalized by each laser wavelength. In embodiment 1, the phase difference by wavelength plate 2 is set to 2310 nm which is 3.5 times 660 nm and the phase difference by wavelength plate 3 is set to 1962.5 nm which is 2.5 times 785 nm. Through setting in this manner, the wavelength plate 2 generates at 660 nm a phase difference of about 3.5 λ as indicated at black square mark in the figure, that is, acts as a half wavelength plate and generates at 785 nm a phase difference of 2.97 λ (about 3 λ) as indicated at white square mark in the figure, that is, acts as an about 1/1 wavelength plate. On the other hands, the wavelength plate 3 generates at 785 nm a phase difference of about 2.5 λ as indicated at white circle mark in the figure, that is, acts as a half wavelength plate and generates at 660 nm a phase difference of 2.94 λ (about 3 λ) as indicated at black circle mark in the figure, that is, acts as an about 1/1 wavelength plate. Accordingly, the wavelength plate 2 acts as the half wavelength plate for only 660 nm and the wavelength plate 3 acts as the half wavelength plate for only 785 nm.

Structurally, with a view to minimizing the amounts of change in the phase differences by the individual wavelength plates due to temperature dependent changes in laser wavelength, the phase differences by the wavelength plates 2 and 3 are set as small as possible so that the wavelength plate 2 may generate the about 3.5 λ phase difference for the 660 nm optical beam and the wavelength plate 3 may generate the about 2.5 λ phase difference for the 785 nm optical beam. But this is not limitative and the wavelength plate 2 may change the phase by about (M+½) times 660 nm (M being integer) and the wavelength plate 3 may change the phase by about (N+½) times 785 nm (N being integer).

The wavelength plate 2 is so constructed as to generate a phase difference of about 3 λ for the 785 nm optical beam and the wavelength plate 3 is so constructed as to generate a phase difference of about 3 λ for the 660 nm optical beam but this is not limitative and structurally, it suffices that the wavelength plate 2 changes the phase by about K times 785 nm (K being integer) and the wavelength plate 3 changes the phase by about L times 660 nm (L being integer).

Since the phase shift has a permissible value which is approximately 0.1 times the wavelength, the desired characteristics can be obtained when the permissible value is 66 to 79 nm, that is, approximately less than ±100 nm.

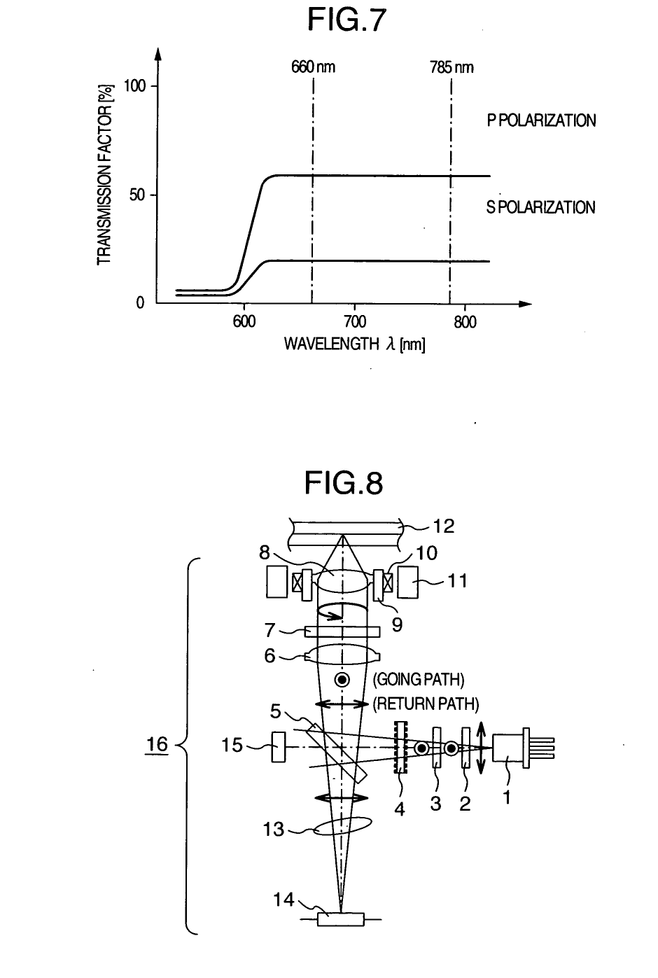

Next, characteristics of the half mirror in embodiment 1 of the invention will be described with reference to FIG. 7. Illustrated in FIG. 7 are characteristics of the half mirror. In FIG. 7, abscissa represents the laser wavelength of an optical beam incident on the half mirror and ordinate represents the transmission factor for the incident optical beam. The characteristics are such that at the film surface 5a of the half mirror disposed by making 45° to the optical beam, 60% of beam in the 660 nm to 785 nm band transmits in the case of an optical beam being in P polarization condition and 20% of beam in the 660 nm to 785 nm band transmits in the case of an optical beam being in S polarization condition. Accordingly, as regards reflection of optical beams of 660 nm to 785 nm, the P polarized light is reflected by 40% and the S polarized light is reflected by 80%.

FIG. 8 is a diagram showing the polarization state during reproduction of the first optical disc. The individual parts have already been detailed and will not be described herein. The semiconductor laser 1 per se is mounted on the optical pickup 16 so that an optical beam of P polarization having its polarization plane parallel to the sheet of drawing as indicated by arrows in the figure may be emitted from the semiconductor laser 1. The optical beam in 660 nm wavelength band emitted from the laser undergoes a phase difference corresponding to 3.5 λ in the course of its transmission through the wavelength plate 2 having its an azimuth angle set to 45° and consequently, the polarization direction of the optical beam is 90° rotated and the optical beam is in S polarization condition as indicated by circle mark in the figure. Subsequently, this optical beam goes in the wavelength plate 3. Since the wavelength plate 3 is an about 3 λ phase difference generating plate as viewed from the 660 nm laser, the optical beam transmits through the wavelength plate while its S polarization state being kept. Thereafter, the optical beam transmits through the grating 4, undergoes reflection at the half mirror 5 and transmits through the collimator 6. After having transmitted through the collimator 6, the optical beam is made to be incident on the wideband wavelength plate 7. The wideband wavelength plate 7 is adapted to convert the S polarization of the 660 nm optical beam into circle polarization and hence the optical beam in the circle polarization condition as indicated by arrow in the figure heads for the objective lens 8, finally being irradiated on the optical disc 12. An optical beam returning from the optical disc 12 is in circle polarization condition and therefore, the optical beam is converted into linearly polarized light when again transmitting through the wideband wavelength plate 7 but on the returning path, it is in P polarization condition having its oscillation plane in the sheet of drawing. Thereafter, the optical beam in P polarization condition transmits through the half mirror 5 and detecting lens 13, finally reaching the detector 14.

Incidentally, in the event that the polarization direction of the 660 nm optical beam emitted from the semiconductor laser 1 deviates from P polarization by an angle α, the outgoing polarization after transmission through the wavelength plate 2 can be made to be substantially P polarization by adjusting rotation of the wavelength plate 2 in a direction reverse to the deviation direction. More specifically, to cope with the deviation by angle α, the wavelength plate 2 is mounted to the optical pickup 16 in such a manner that a deviation of α/2 can be made in the reverse direction. The adjustment angle is set to not a but α/2 because the half wavelength plate-functions to rotate the polarization direction by an angle twice an angle between azimuth angle and incident polarization angle of the wavelength plate.

On the other hand, the 660 nm optical beam is also incident on the wavelength plate 3 but on account of the fact that the wavelength plate 3 generates a phase difference of 2.94 λ (about 3 λ), that is, acts as an about 1/1 wavelength plate, no substantial rotation of polarization direction occurs and the optical beam goes out while substantially maintaining the polarization state at the time of being incident on the wavelength plate 3.

With the wavelength plates 2 and 3 constructed as above, the 660 nm optical beam can be in substantially accurate P polarization condition. In other words, the polarization state substantially identical to perfect P polarization at the time of emission from the semiconductor laser 1 can be realized and a stable optical system independent of the polarization angle at the time of emission from the semiconductor laser 1 can be materialized.

To add, in the wavelength plate 2, rotation of the polarization direction does not occur apparently for the 785 nm optical beam. This is because for the 785 nm optical beam, the wavelength plate 2 generates a phase difference of 2.97 λ (about 3 λ), that is, acts as an about 1/1 wavelength plate and therefore, no substantial rotation of polarization direction occurs and the optical beam is outputted while maintaining the incoming polarization state substantially. Namely, the wavelength plate 2 acts as a half wavelength plate for only the 660 nm optical beam. As regards the wavelength plate 2 in this phase, sufficient effects can be obtained if the unevenness in phase difference is within ±0.1 λ.

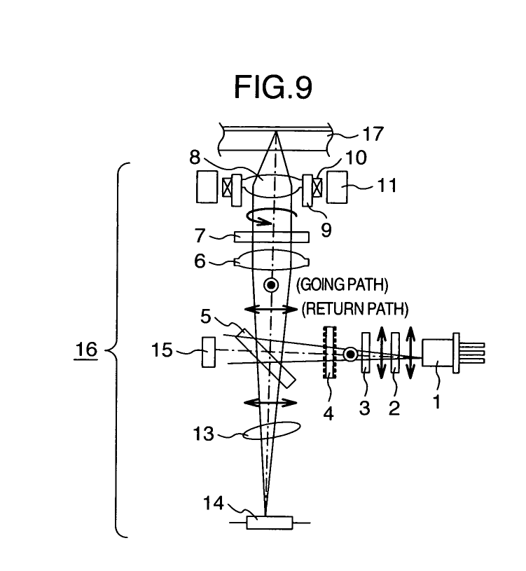

FIG. 9 is a diagram showing the polarization state during reproduction of the second optical disc. The individual parts have already been detailed and will not be described herein. The semiconductor laser 1 per se is mounted on the optical pickup 16 so that an optical beam of P polarization having its polarization plane parallel to the sheet of drawing as indicated by arrows in the figure may be emitted from the semiconductor laser 1. The optical beam in 785 nm wavelength band emitted from the laser is made to be incident on the wavelength plate 2. Since the wavelength plate 2 is an about 3 λ phase difference generating plate as viewed from the laser of 785 nm, the optical beam transmits through the wavelength plate while its P polarization state being kept. The optical beam having transmitted through the wavelength plate 2 is given a phase difference corresponding to 2.5 λ in the course of its transmission through the wavelength plate 3 having an azimuth angle set to 45° and as result, the polarization direction of the outgoing optical beam is changed to 90° rotated S polarization as indicated at circle mark in the figure. Thereafter, the optical beam transmits through the grating 4, undergoes reflection at the half mirror 5 and transmits through the collimator 6. After having transmitted through the collimator 6, the optical beam is made to be incident on the wideband wavelength plate 7. The wideband wavelength plate 7 is adapted to convent the S polarization of the 785 nm optical beam into circle polarization and hence the optical beam in circle polarization condition as indicated by arrow in the figure heads for the objective lens 8, finally being irradiated on the optical disc 17. An optical beam returning from the optical disc 17 is in circle polarization condition and therefore, the optical beam is converted into linear polarization when again transmitting through the wideband wavelength plate 7 but on the returning path, it is in P polarization condition having its oscillation plane in the sheet of drawing. Thereafter, the optical beam in P polarization condition transmits through the half mirror 5 and detecting lens 13, finally reaching the detector 14.

Incidentally, in the event that the polarization direction of the 785 nm optical beam emitted from the semiconductor laser 1 deviates from P polarization by an angle β, the outgoing polarization after transmission through the wavelength plate 3 can be made to be substantially P polarization by adjusting rotation of the wavelength plate 3 in a direction reverse to the deviation direction. More specifically, to cope with the deviation of angle β, the wavelength plate 3 is mounted to the optical pickup 16 in such a manner that a deviation of β/2 can be made in the reverse direction. The adjustment angle is set to not β but β/2 because the half wavelength plate functions to rotate the polarization direction by an angle twice an angle between azimuth angle and incident polarization angle of the wavelength plate.

On the other hand, the 785 nm optical beam is also incident on the wavelength plate 2 but on account of the fact that the wavelength plate 2 generates a phase difference of 2.97 λ (about 3 λ), that is, acts as an about 1/1 wavelength plate, no substantial rotation of polarization direction occurs and the optical beam goes out while substantially maintaining the polarization state at the time of being incident on the wavelength plate 2.

With the wavelength plates 2 and 3 constructed as above, the 785 nm optical beam can be in substantially accurate P polarization. In other words, the polarization state substantially identical to perfect P polarization at the time of emission from the semiconductor laser 1 can be realized and a stable optical system independent of the polarization angle at the time of emission from the semiconductor laser 1 can be materialized.

To add, in the wavelength plate 3, rotation of the polarization direction does not occur apparently for the 660 nm optical beam. This is because for the 660 nm optical beam, the wavelength plate 3 generates a phase difference of 2.94 λ (about 3 λ), that is, acts as an about 1/1 wavelength plate and therefore, no substantial rotation of polarization direction occurs and the optical beam is outputted while maintaining the incoming polarization state substantially. Namely, the wavelength plate 3 acts as a half wavelength plate for only the 785 nm optical beam. As regards the wavelength plate 3 in this phase, sufficient effects can be obtained if the unevenness in phase difference is within ±0.1 λ.

The 660 nm and 785 nm optical beams having passed through the wavelength plates 2 and 3 are in linear polarization states in which the polarization directions substantially coincide with each other. Each of the wavelength plate 2 and 3 can be rotated independently about the center axis represented by the optical axis of the 660 nm optical beam or the optical axis of the 785 nm optical beam.

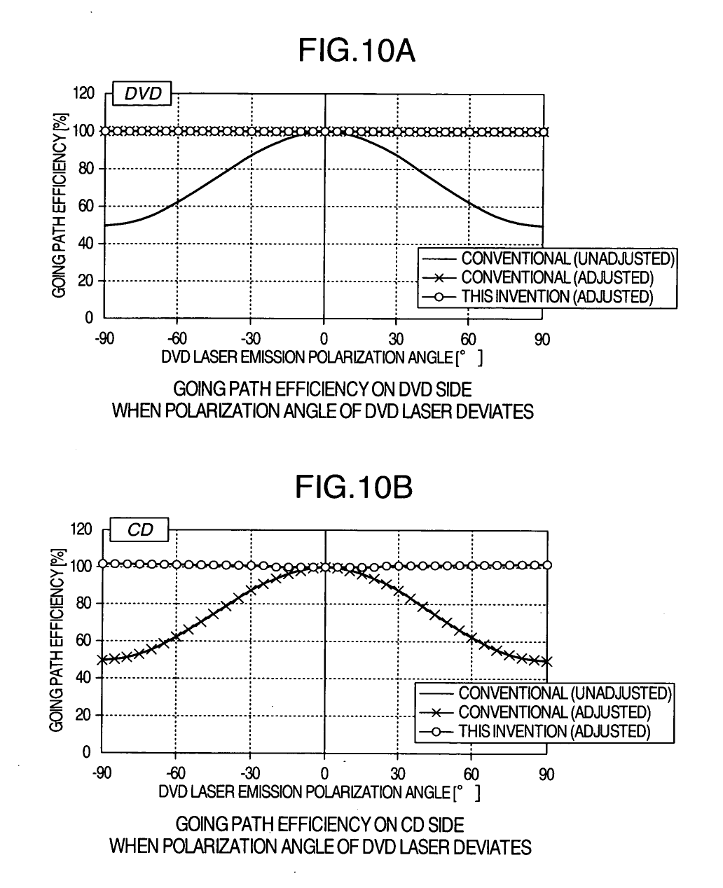

Next, the optical efficiency when the polarization angle of laser deviates will be described. Illustrated in FIGS. 10A and 10B are results of calculation of going path efficiency when the emission polarization angle of 660 nm DVD deviates. FIG. 10A shows the going path efficiency on the DVD side and FIG. 10B shows that on the CD side. In any of the figures, abscissa represents the DVD laser emission polarization angle and ordinate represents the optical efficiency in the going path. In these figures, calculation results are obtained with the optical system configuration in the present embodiment and the conventional optical system configuration and as the conventional optical system configuration, an optical system is assumed in which in place of the wavelength plates 2 and 3, a single wideband half wavelength plate is disposed in front of the semiconductor laser 1. The wideband half wavelength plate referred to herein is a wavelength plate which acts as a half wavelength plate for any of the 660 nm DVD wavelength and the 785 nm CD wavelength. Assumptively, the wavelength plate is conditioned for adjustment in angle such that rotation is adjusted to enable each emission polarization angle to be converted into S polarization condition after transmission through the wavelength plate and the going path efficiency is maximized.

In FIG. 10A, when the emission polarization angle of DVD laser deviates, the going path efficiency can be prevented from being degraded in any of the conventional configuration and the present embodiment by making rotation adjustment of the wavelength plate. On the other hand, if no adjustment is made in the conventional configuration, the going path efficiency varies owing to deviation of polarization angle in the case of DVD.

Illustrated in FIG. 10B is the going path efficiency on the CD side when the emission polarization angle of DVD laser deviates. In the present embodiment, even with the wavelength plate 2 rotated to comply with the polarization angle for DVD, the going path efficiency on the CD side is not affected. In the conventional configuration, on the other hand, when the angle adjustment of wideband wavelength plate is made to comply with the deviation of laser polarization angle on DVD side, the incident angle is rotated with respect to the azimuth angle of the wideband wavelength plate as viewed from the laser on CD side, with the result that the going path efficiency after the adjustment varies greatly in accordance with the emission polarization angle of DVD laser. In case the rotation adjustment of the wideband wavelength plate is not made on the DVD side in the conventional configuration, the going path efficiency does not vary on the CD side.

As will be seen from the above, the going path efficiency is caused to vary on any of DVD side and CD side in response to the deviation of emission polarization angle of DVD laser regardless of the presence or absence of the rotation adjustment of wideband wavelength plate in the conventional configuration whereas the going path efficiency can be prevented from varying on any of DVD side and CD side by making rotation adjustment of the wavelength plate in accordance with the polarization in the present embodiment.

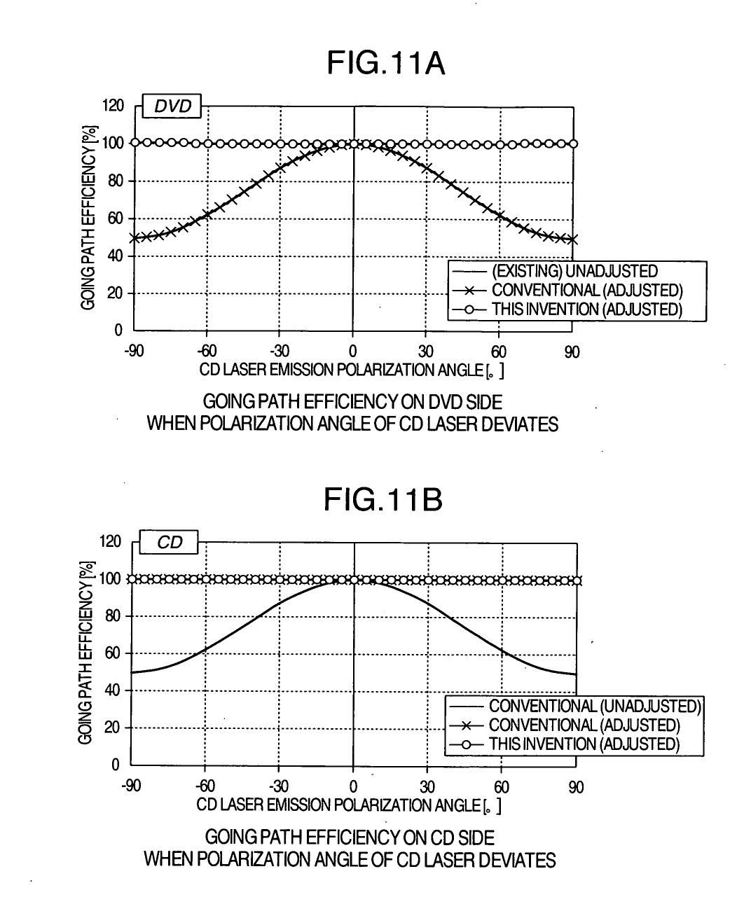

Next, a description will be given of the optical efficiency when the emission polarization angle of laser on the CD side deviates. FIGS. 11A and 11B show results of calculation of the going path efficiency when the emission polarization angle of 785 nm CD laser deviates. FIG. 11A illustrates the going path efficiency on the DVD side and FIG. 11B illustrates the going path efficiency on the CD side. In any of the figures, abscissa represents the CD laser emission polarization angle and ordinate represents the optical efficiency in the going path. Like the description given in connection with FIGS. 10A and 10B, results of calculation obtained with the optical system configuration of the present embodiment and the conventional optical system configuration are depicted in the figures.

In FIG. 11A, when the emission polarization angle of CD laser deviates, the going path efficiency can be prevented from being varied on the DVD side by making the rotation adjustment of wavelength plate 3 in the present embodiment. In the conventional configuration, the going path efficiency does not vary on the DVD side when the wideband wavelength plate is not adjusted. On the other hand, if the rotation adjustment of wideband wavelength plate is made in response to the polarization angle of CD laser in the conventional configuration, the azimuth angle of wideband wavelength plate relative to the polarization angle of DVD laser is seen as being varied, with the result that the going path efficiency on the DVD is varied in response to the deviation of polarization angle of CD laser.

Illustrated in FIG. 11B is the going path efficiency on the CD side when the polarization angle of CD laser varies. Structurally, in the present embodiment, the going path efficiency on the CD side can be prevented from being varied by making rotation adjustment of wavelength plate 3 to comply with the polarization angle of CD laser. Without the rotation adjustment of wideband wavelength plate on the CD side in the conventional configuration, the incident angle relative to the azimuth angle of the wideband wavelength plate is rotated as viewed from the laser on the CD side, thus causing the going path efficiency to be varied greatly in accordance with the emission polarization angle of CD laser whereas with the angle adjustment of wideband wavelength plate made in accordance with the deviation of CD laser polarization angle, the going path efficiency can be prevented from being varied on the CD side.

As will be seen from the above, while in the conventional configuration the going path efficiency is varied on any of the DVD side and CD side in response to the deviation of the emission polarization angle of CD laser irrespective of the presence or absence of the adjustment of the wideband wavelength plate, the going path efficiency can be prevented from being varied on any of the DVD side and CD side by making the rotation adjustment of wavelength plate in accordance with polarization in the present embodiment, thereby assuring that the performance of the optical pickup can be made to be stable.

[Embodiment 2]

Next, embodiment 2 of the present invention will be described.

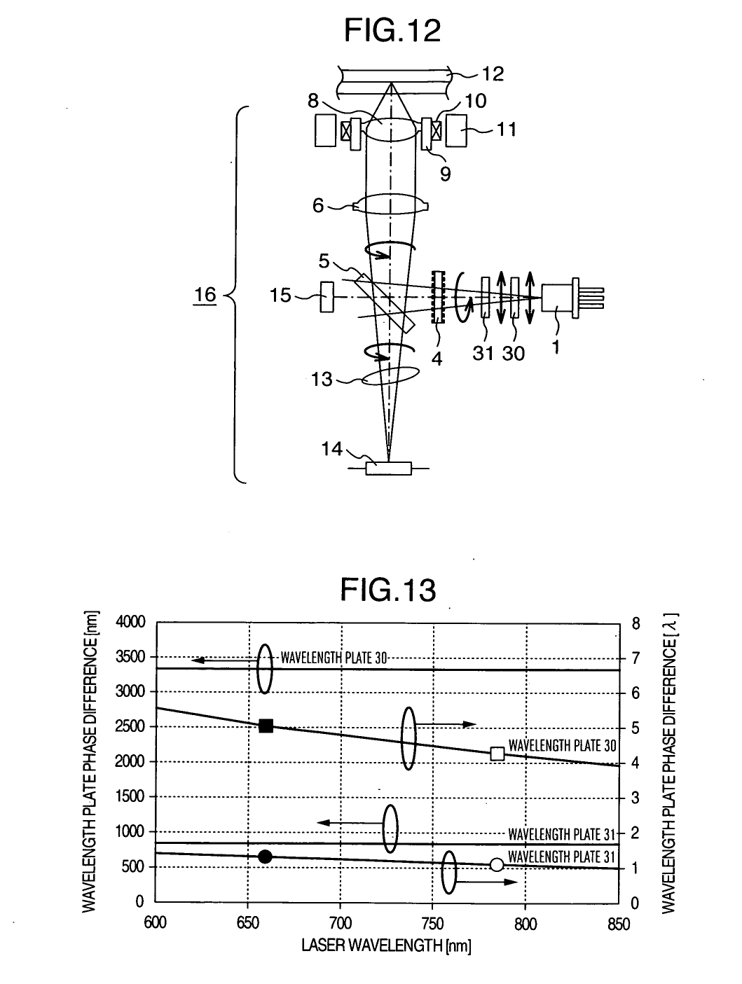

FIG. 12 shows the construction of an optical system of an optical pickup according to embodiment 2. Embodiment 2 differs from embodiment 1 shown in FIG. 1 in that in the optical system configuration of optical pickup 16, wavelength plates 30 and 31 substituting for the wavelength plates 2 and 3 are disposed in front of the semiconductor laser 1 and the wideband wavelength pate 7 is eliminated. The wavelength plate 30 acts as a quarter wavelength plate for the CD of 785 nm and a 1/1 wavelength plate for the DVD of 660 nm. The wavelength plate 31 acts as a quarter wavelength plate for the DVD of 660 nm and a 1/1 wavelength plate for the CD of 785 nm, these wavelength plates 30 and 31 having characteristics to be detailed later.

Then, FIG. 12 shows the state in which the laser for DVD is turned on. The semiconductor laser 1 per se is mounted on the optical pickup 16 such that an optical beam in P polarization condition having its polarization plane parallel to the sheet of drawing as indicated by arrows in the figure is emitted from the semiconductor laser 1. The 660 nm optical beam having a wavelength in 660 nm band emitted from the laser transmits through the wavelength plate 30 having its azimuth angle set to 45° but since the wavelength plate 30 is a 1/1 wavelength plate as viewed from the 660 nm laser, the optical beam transmits through it without changing the polarization state of P polarization. Thereafter, the optical beam enters the wavelength plate 31 acting as a quarter wavelength plate for the 660 nm laser beam, with the result that the optical beam having transmitted through the wavelength plate 31 is in polarization direction subject to circle polarization as indicated by arrow in the figure. Subsequently, the optical beam transmits through the grating 4 and undergoes reflection at the half mirror 5. Structurally, the half mirror has characteristics exhibiting substantially the same reflection factor to the both components of P polarization and S polarization as will be described later and hence the polarization direction the optical beam having undergone reflection at the half mirror 5 maintains the circle polarization state. After being reflected at the half mirror 5, the optical beam transmits through the collimator 6 and heads for the objective lens 8, finally being irradiated on the optical disc 12. An optical beam returning from the optical disc 12 is in circle polarization condition and after transmitting through the collimator 6, transmits through the half mirror 5 and detecting lens 13 while keeping its circle polarization and comes to the detector 14. In embodiment 2, with the optical system configured as above, the wideband wavelength plate disposed behind the collimator 6 can be eliminated as compared to embodiment 1.

Now, in the event that the polarization direction of the 660 nm optical beam emitted from the semiconductor laser 1 deviates from P polarization by angle α, the outgoing polarization after transmission through the wavelength plate 31 can be circle polarization by adjusting rotation of wavelength plate 31 by α in the present embodiment. As a result, for the optical beam in the stage succeeding the wavelength plate 31, the polarization state substantially identical to the perfect P polarization of emission polarization from the semiconductor laser 1 as described previously can be realized, thus materializing a stable optical system independent of the emission polarization angle of semiconductor laser 1.

Further, with the 785 nm CD laser turned on though not illustrated, in the event that the polarization direction of the 785 nm optical beam emitted from the semiconductor laser 1 deviates from the P polarization by angle β, the outgoing polarization after transmission through the wavelength plate 30 can be circle polarization by making the rotation adjustment of wavelength plate 30 by β.

FIG. 13 shows characteristics of the wavelength plates 30 and 31. In FIG. 13, abscissa represents the laser wavelength of an optical beam incident on the wavelength plate, ordinate on the left side represents the phase difference the wavelength plate generates in a unit of length and ordinate on the right side represents the phase difference the wavelength plate generates which is normalized by each laser wavelength. In embodiment 2, the phase difference by wavelength plate 30 is set to 3336.25 nm and that by wavelength plate 31 is set to 825 nm. Through setting in this manner, the wavelength plate 30 generates a phase difference of 5.05 λ (about 5 λ) at 660 nm as indicated by black square mark in the figure, that is, acts as an about 1/1 wavelength plate and generates at 785 nm a phase difference of 4.25 λ as indicated by white square mark in the figure, that is, acts as a quarter wavelength plate. On the other hand, the wavelength plate 31 generates a phase difference of 1.05 λ (about 1 λ) at 785 nm as indicated by white circle in the figure, that is, acts as an about 1/1 wavelength plate and generates a phase difference of 1.25 λ at 660 nm as indicated by black circle in the figure, that is, acts as a quarter wavelength plate. Thus, the wavelength plate 30 acts as the quarter wavelength plate for only 660 nm and the wavelength plate 31 acts as the quarter wavelength plate for only 785 nm.

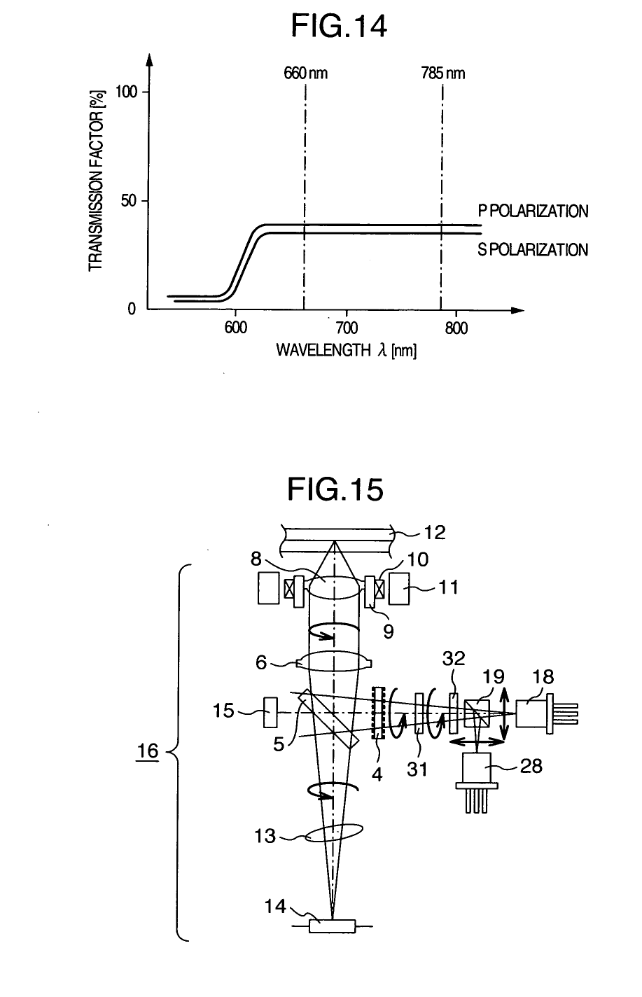

Next, characteristics of the half mirror in embodiment 2 will be described with reference to FIG. 14. Illustrated in FIG. 14 are characteristics of the half mirror 5. In FIG. 14, abscissa represents the laser wavelength of an optical beam incident on the half mirror 5 and ordinate represents the transmission factor for the incident optical beam. The characteristics are such that at the film surface 5a of the half mirror 5 disposed by making an angle of 45° to the optical beam, 40% of beam in the 660 nm to 785 nm band transmits in the case of an optical beam in P polarization condition and 35% of beam in the 660 nm to 785 nm band transmits in the case of an optical beam in S polarization condition. Accordingly, as regards reflection of 660 nm to 785 nm optical beams, the P polarized light is reflected by 60% and the S polarized light is reflected by 65%, thereby ensuring that a reflection factor of about 60% can be assured irrespective of the polarization state incident on the half mirror 5.

[Embodiment 3]

Next, embodiment 3 of the present invention will be described.

FIG. 15 shows the construction of an optical system of an optical pickup according to embodiment 3. Embodiment 3 differs from embodiment 2 shown in FIG. 12 in that in the optical system configuration of optical pickup 16, a semiconductor laser 18 for 660 nm DVD and a semiconductor laser 28 for, for example, 405 nm BD substitute for the semiconductor laser 1 representing the two-wavelength laser. An optical beam emitted from the semiconductor laser 18 for DVD reaches a prism 19. The prism 19 transmits the beam of wavelength for DVD by 100% irrespective of the polarization state and reflects the beam of wavelength for BD by 100% by means of an internally formed reflection film. Accordingly, the optical beam emitted from the semiconductor laser 18 transmits the prism 19 by 100% to reach the wavelength plate 32. On the other hand, the optical beam emitted from the semiconductor laser 28 for BD undergoes 100% reflection irrespective of the polarization state by means of the reflection film disposed internally of the prism 19 at an angle of 45° and reaches the wavelength plate 32. In other words, in the optical system configuration of embodiment 3, the optical beams emitted from the two different semiconductor lasers are synthesized by the prism and an optical beam after synthesis is made to be incident on the two wavelength plates.

Here, the wavelength plate 32 acts as a quarter wavelength plate for the 405 nm BD and as a 1/1 wavelength plate for the 660 nm DVD. Then, the wavelength plate 31 acts as a quarter wavelength plate for the 660 nm DVD and as a 1/1 wavelength plate for the 405 nm BD. The wavelength plates 31 and 32 have characteristics to be detailed later.

Then, FIG. 15 shows the state that the lasers for DVD and BD are turned on. The semiconductor laser 18 per se is mounted on the optical pickup 16 so that an optical beam in P polarization condition having its polarization plane parallel to the sheet of drawing as indicated by arrows may be emitted from the semiconductor laser 18. The optical beam in 660 nm band wavelength emitted from the laser transmits through the prism 19 to reach the wavelength plate 32 as described previously. Here, the wavelength plate 32 has an azimuth angle set to 45° and is a 1/1 phase difference plate as viewed from the 660 nm laser, so that the optical beam transmits through the wavelength plate without changing the polarization state of P polarization. Thereafter, the optical beam is made to be incident on the wavelength plate 31 and because of the wavelength plate 31 acting as the quarter wavelength plate for the 660 nm laser, the polarization direction of an optical beam having transmitted through the wavelength plate 31 is changed to circle polarization as indicated by arrow in the figure. Subsequently, the optical beam transmits through the grating 4 and undergoes reflection at the half mirror 5. Structurally, the half mirror 5 has such characteristics that as described in connection with embodiment 2 of FIG. 14, its reflection factor is substantially the same for both the P polarization and S polarization and therefore, the polarization direction of the optical beam subjected to reflection at the half mirror 5 maintains the circle polarization state. After being reflected at the half mirror 5, the optical beam transmits through the collimator 6 and heads for the objective lens 8, finally being irradiated on the optical disc 12. An optical beam returning from the optical disc 12 is in the polarization condition of circle polarization and after having transmitted through the collimator 6, transmits through the half mirror 5 and detecting lens 13 while being in circle polarization condition and reaches the detector 14.

Then, in the event that the polarization direction of the 660 nm optical beam emitted from the semiconductor laser 18 deviates from P polarization by angle α, the outgoing polarization after transmission through the wavelength plate 31 can be made to be circle polarization by making rotation adjustment of the wavelength plate 31 by α in the present embodiment. Accordingly, for an optical beam in the stage succeeding the wavelength plate 31, the polarization state substantially identical to that in the case where the emission polarization from the semiconductor laser 18 is perfect P polarization as described previously can be realized and a stable optical system independent of the emission polarization angle of the semiconductor laser 18 can be materialized.

With the semiconductor laser 28 for BD turned on, in the event that the polarization direction of the 405 nm optical beam emitted from the semiconductor laser 28 deviates from the P polarization by angle β, the outgoing polarization after transmission through the wavelength plate 32 can be made to be circle polarization by making rotation adjustment of the wavelength plate 32 by β.

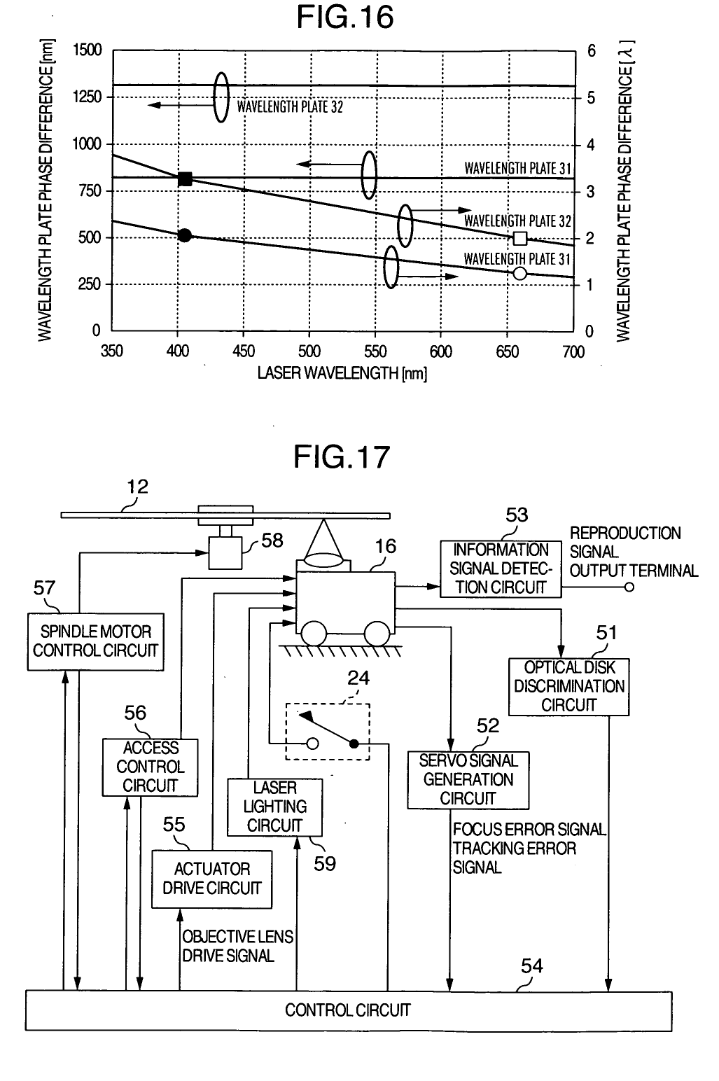

Next, characteristics of the wavelength plates in embodiment 3 will be described. FIG. 16 shows characteristics of the wavelength plates 31 and 32. In FIG. 16, abscissa represents the laser wavelength of an optical beam incident on the wavelength plate, ordinate on the left side represents the wavelength plate phase difference in a unit of length and ordinate on the right side represents the wavelength plate phase difference normalized by each laser wavelength. In embodiment 3, the wavelength plate 31 has a phase difference set to 825 nm and the wavelength plate 32 has a phase difference set to 1316.25 nm. Through this setting, the wavelength plate 31 generates a phase difference of 2.04 λ (about 2 λ) at 405 nm as indicated by black circle mark in the figure, that is, acts as an about 1/1 wavelength plate and a phase difference of 1.25 λ at 660 nm as indicated by white circle mark in the figure, that is, acts as a quarter wavelength plate. On the other hand, the wavelength plate 32 generates a phase difference of 1.99 λ (about 2 λ) at 660 nm as indicated by white square mark in the figure, that is, acts as an about 1/1 wavelength plate and a phase difference of 3.25 λ at 405 nm as indicated by black square mark in the figure, that is, acts as a quarter wavelength plate, demonstrating that the wavelength plate 31 can act as the quarter wavelength plate for only 660 nm and the wavelength plate 32 can act as the quarter wavelength plate for only 405 nm.

As described above, according to the present embodiment, in association with the semiconductor lasers for emitting two or more laser beams of different wavelengths, the two wavelength plates capable of setting the polarization states independently of each other are arranged on the common optical path and by adjusting rotation of them independently of each other, the polarization state in the optical path succeeding the two wavelength plates can be stabilized, thereby realizing an optical system in which the optical efficiency does not vary in response to variations in polarization angle of the semiconductor laser.

[Embodiment 4]

Next, an optical disc apparatus carrying the optical pickups of embodiments 1 to 3 will be described. FIG. 17 is a schematic block diagram showing an optical disc apparatus carrying the optical pickups according to the present embodiment. Part of a signal detected by an optical pickup 16 is sent to an optical disc discrimination circuit 51. When comparing an instance where the substrate thickness of the optical disc corresponds to an oscillation wavelength of the turned-on semiconductor laser with an instance where it corresponds to a different oscillation wavelength, a focus error signal amplitude level, for example, detected by the optical pickup 16 is larger in the former case than in the latter case and this phenomenon is utilized for operation of optical disc discrimination by the optical disc discrimination circuit 51. A result of discrimination is sent to a control circuit 54. Further, the detection signal detected by the optical pickup 16 is partly sent to a servo signal generation circuit 52 or an information signal detection circuit 53. In the servo signal generation circuit 52, a focus error signal or tracking error signal suited to the optical disc 12 or 17 is generated from various kinds of signals detected by the optical pickup 16 and is sent to the control circuit 54. On the other hand, the information signal detection circuit 53 detects from the detection signal of optical pickup 16 a signal indicative of information recorded on the optical disc 12 or 17 which in turn is delivered to a reproduction signal output terminal. Responsive to the signal from the optical disc discrimination circuit 51, the control circuit 54 sets the optical disc 12 or 17 and on the basis of a focus error signal or tracking error signal generated by the servo signal generation circuit 52 in correspondence with the setting, sends an objective lens drive signal to an actuator drive circuit 55. Responsive to the objective lens drive signal, the actuator drive circuit 55 drives the actuator 9 in the optical pickup 16 to control the position of the objective lens 8. Further, the control circuit 54 responds to an access control circuit 56 to control access direction/position of the optical pickup 16 and responds to a spindle motor control circuit 57 to control rotation of a spindle motor 58 to thereby rotate the optical disc 12 or 17. Further, the control circuit 54 drives a laser lighting circuit 59 to suitably turn on the semiconductor laser 1 mounted on the optical pickup 16 in accordance with the optical disc 12 or 17, thereby realizing recording/reproduction operation in the optical disc apparatus.

Then, by providing an information signal reproduction unit for reproducing an information signal from the signal outputted from the optical pickup and an output unit for outputting the signal delivered out of the information signal reproduction unit, an apparatus for reproducing the optical disc can be constructed. And also, by providing an information input unit for inputting an information signal and a recording signal generation unit for generating a signal to be recorded on the optical disc from the information inputted from the information input unit and delivering the thus generated signal to the optical pickup, a recording apparatus for the optical disc can be constructed.

As described above, according to the foregoing embodiments, even for any of the two optical beams emitted from the two-wavelength laser, the polarization direction can be adjusted independently and the optical beam output and polarization state on the optical disc can be made to be constant, thus making it possible to realize highly reliable optical pickup and optical disc apparatus.

The present invention is in no way limited to the construction of each of the foregoing embodiments and other various constructions can be adopted. For example, in embodiments 1 and 2, the optical pickup for recording or reproducing the DVD and CD has been described but it can be applied to an optical pickup for recording or reproducing the BD and DVD.

The forgoing description is given of the embodiments but the present invention is not limited to them and it is obvious to those skilled in the art that various changes and modifications can be made without departing from the spirit of the present invention and the scope of appended claims.

1. An optical pickup comprising:
a first laser light source for emitting an optical beam of a first wavelength;
a second laser light source for emitting an optical beam of a second wavelength different from said first wavelength;
a first polarizing device through which said optical beams of first and second wavelengths transmit;
a second polarizing device through which said optical beams of first and second wavelengths transmit; and
an objective lens for focusing an optical beam having transmitted through said first and second polarizing devices on an optical disc,
wherein said first polarizing device changes the phase of said optical beam of first wavelength by about (M+½) times said first wavelength (M being integer) and said second polarizing device changes the phase of said optical beam of second wavelength by about (N+½) times said second wavelength (N being integer).

2. An optical pickup according to claim 1, wherein said first polarizing device changes the phase of said optical beam of second wavelength by about K times said second wavelength (K being integer) and said second polarizing device changes the phase of said optical beam of first wavelength by about L times said first wavelength (L being integer).

3. An optical pickup according to claim 1, wherein said first and second polarizing devices are rotatable independently of each other about a center axis represented by the optical axis of said optical beam of first wavelength or represented by the optical axis of said optical beam of second wavelength.

4. An optical pickup according to claim 1, wherein said optical beams of first and second wavelengths having transmitted through said both first and second polarizing devices are linearly polarized beams having polarization directions which are substantially coincident with each other.

5. An optical pickup according to claim 1, wherein said first wavelength is about 660 nm and said second wavelength is about 785 nm.

6. An optical pickup according to claim 1, wherein said first polarizing device generates a phase difference of about 2310 nm and said second polarizing device generates a phase difference of about 1962.5 nm.

7. An optical pickup according to claim 1, wherein said first and second laser light sources are mounted on the same laser module to form a two-wavelength laser.

8. An optical pickup comprising:
a first laser light source for emitting an optical beam of a first wavelength;
a second laser light source for emitting an optical beam of a second wavelength different from said first wavelength;
a first polarizing device through which said optical beams of first and second wavelengths transmit;
a second polarizing device through which said optical beams of first and second wavelengths transmit; and
an objective lens for focusing an optical beam having transmitted through said first and second polarizing devices on an optical disc,
wherein said first polarizing device changes the phase of said optical beam of first wavelength by about (I+¼) times said first wavelength (I being integer) and said second polarizing device changes the phase of said optical beam of second wavelength by about (J+¼) times said second wavelength (J being integer).

9. An optical pickup comprising:
a first laser light source for emitting an optical beam of a first wavelength;
a second laser light source for emitting an optical beam of a second wavelength;
a first polarizing device through which said optical beams of first and second wavelengths transmit;
a second polarizing device through which said optical beams of first and second wavelengths transmit; and
an objective lens for focusing an optical beam having transmitted through said first and second polarizing devices on an optical disc,
wherein said first polarizing device acts as a half wavelength plate for only said optical beam of first wavelength and said second polarizing device acts as a half wavelength plate for only said optical beam of second wavelength.

10. An optical pickup according to claim 9, wherein said first polarizing device acts on said optical beam of second wavelength to cause it not to change its polarization state and said second polarizing device acts on said optical beam of first wavelength to cause it not to change its polarization state.

11. An optical pickup comprising:
a first laser light source for emitting an optical beam of a first wavelength;
a second laser light source for emitting an optical beam of a second wavelength;
a first polarizing device through which said optical beams of first and second wavelengths transmit;
a second polarizing device through which said optical beams of first and second wavelengths transmit; and
an objective lens for focusing an optical beam having transmitted through said first and second polarizing devices on an optical disc,
wherein said first polarizing device changes the polarization state of said first optical beam and said second polarizing device changes the polarization state of said second optical beam.

12. An optical disc apparatus comprising:
an optical pickup as recited in claim 1;
an optical disc discrimination unit for discriminating the kind of optical disc; and
a laser control unit for controlling the emission of said optical beam,
wherein on the basis of a result of discrimination by said optical disc discrimination unit, said laser control unit controls turn-on of the first or second laser light source of said optical pickup.

13. An optical disc apparatus comprising:
an optical pickup as recited in claim 1;
an information signal reproduction unit for reproducing information signal from a signal outputted from said optical pickup; and
an output unit for outputting a signal delivered out of said information signal reproduction unit.

14. An optical disc apparatus comprising:
an optical pickup as recited in claim 1;
an information input unit for inputting an information signal; and
a recording signal generation unit for generating a signal to be recorded on an optical disc from information inputted through said information input unit and delivering it to said optical pickup.
